(19) United States
(12) Patent Application Publication
(10) Pub. No.: US 2024/0220715 A1
(43) Pub. Date: Jul. 4, 2024

(54) METHOD AND APPARATUS FOR MANAGEMENT AND VALIDATION OF DATA

(71) Applicant: RAKUTEN SYMPHONY SINGAPORE PTE. LTD., Singapore (SG)

(72) Inventors: Asfak KHAN, Indore (IN); Aman SHEIKH, Indore (IN); Arpit BHESANIYA, Indore (IN); Yatin AGRAWAL, Indore (IN)

(73) Assignee: RAKUTEN SYMPHONY SINGAPORE PTE. LTD., Singapore (SG)

(21) Appl. No.: 17/909,195

(22) PCT Filed: Jul. 5, 2022
(86) PCT No.: PCT/US2022/036091

§ 371 Date: Sep. 2, 2022

(51) Int. Cl. G06F 40/18

(52) U.S. Cl. CPC G06F 40/18

(57) ABSTRACT

A method is performed by at least one processor for data validation in an electronic spreadsheet displayed in a user interface. The method includes receiving a selection of a set of data that includes a plurality of data cells arranged in at least one row and a plurality of data columns. The method further includes receiving a location in the electronic spreadsheet for insertion of the set of data. The method further includes, after receiving the location in the electronic spreadsheet, validating the set of data based on a master data configuration stored in one or more databases. The method further includes, after validating the set of data, displaying a message in the user interface indicating whether the validating the set of data is successful.

### TECHNICAL FIELD

The present disclosure relates generally to electronic spreadsheet generation, and more particularly to methods and apparatuses for management and validation of data.

### BACKGROUND

During budget planning or any kind of planning activity, a user often refers to past or historical data in bulk. For example, when preparing a spreadsheet for current use, the user may refer to a previously prepared spread sheet to copy bulk data containing a plurality of rows and columns. However, when the user pastes this data in another spreadsheet, the bulk data is inserted without proper validation with current master data to maintain accuracy. In this regard, a user can perform a copy-paste operation on multiple rows in an online spreadsheet such as Box and Google Sheets. However, the user is unable to define or fetch dependent columns data from any configurations. Therefore, the user is unable to perform proper validations on the multiple rows of data.

Certain conditions and constraints on the data may have changed since the previous spreadsheet was prepared. As such, when copying and pasting bulk data, a user needs to compare each individual cell with current master data to individually validate each cell, which is a time consuming process. Therefore, there exists a need for performing validation of bulk data, particularly data containing multiple rows and data columns. Improvements are presented herein.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for validating bulk data are disclosed by the present disclosure.

According to exemplary embodiments, a method is performed by at least one processor for data validation in an electronic spreadsheet displayed in a user interface. The method includes receiving a selection of a set of data that includes a plurality of data cells arranged in at least one row and a plurality of data columns. The method further includes receiving a location in the electronic spreadsheet for insertion of the set of data. The method further includes, after receiving the location in the electronic spreadsheet, validating the set of data based on a master data configuration stored in one or more databases. The method further includes, after validating the set of data, displaying a message in the user interface indicating whether the validating the set of data is successful.

According to exemplary embodiments, an apparatus for data validation in an electronic spreadsheet displayed in a user interface includes at least one memory configured to store computer program code. The apparatus further includes at least one processor configured to access said at least one memory and operate as instructed by said computer program code. The computer program code includes first receiving code configured to cause at least one of said at least one processor to receive a selection of a set of data that includes a plurality of data cells arranged in at least one row and a plurality of data columns. The computer program code further includes second receiving code configured to cause at least one of said at least one processor to receive a location in the electronic spreadsheet for insertion of the set of data. The computer program code further includes, after reception of the location in the electronic spreadsheet, validating code configured to cause at least one of said at least one processor to validate the set of data based on a master data configuration stored in one or more databases. The computer program code further includes, after validation of the set of data, displaying code configured to cause at least one of said at least one processor to display a message in the user interface indicating whether the validating the set of data is successful.

According exemplary embodiments, a non-transitory computer readable medium has instructions stored therein, which when executed by a processor cause the processor to perform a method for data validation in an electronic spreadsheet displayed in a user interface. The method includes receiving a selection of a set of data that includes a plurality of data cells arranged in at least one row and a plurality of data columns. The method further includes receiving a location in the electronic spreadsheet for insertion of the set of data. The method further includes, after receiving the location in the electronic spreadsheet, validating the set of data based on a master data configuration stored in one or more databases. The method further includes, after validating the set of data, displaying a message in the user interface indicating whether the validating the set of data is successful.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example processing device for performing data validation in accordance with various embodiments of the present disclosure.

FIG. 2 is an example user interface in accordance with various embodiments of the present disclosure.

FIG. 3 is an example user interface illustrating a copy-paste operation of bulk data in accordance with various embodiments of the present disclosure.

FIG. 4 is an example user interface illustrating a data validation success message in accordance with various embodiments of the present disclosure.

FIG. 5 is an example user interface illustrating a data validation error message in accordance with various embodiments of the present disclosure.

FIG. 6 is an example user interface illustrating a master data configuration in accordance with various embodiments of the present disclosure.

FIG. 7 is an example tree diagram representing a master data configuration in accordance with various embodiments of the present disclosure.

FIG. 8 illustrates a flow chart of an example process of validating bulk data, in accordance with various embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Embodiments of the present disclosure provide multi row copy-paste functionality for dependent columns with proper validations. In some embodiments, a master data configuration may specify relationships between columns in a spreadsheet. As an example, a data column specified in the master data configuration that depends on a value of another data column specified in the master data configuration may be referred to as a dependent column. A user may change data of dependent columns at any time in the master data configuration. Dependent columns may be validated at the time a copy-paste function is performed.

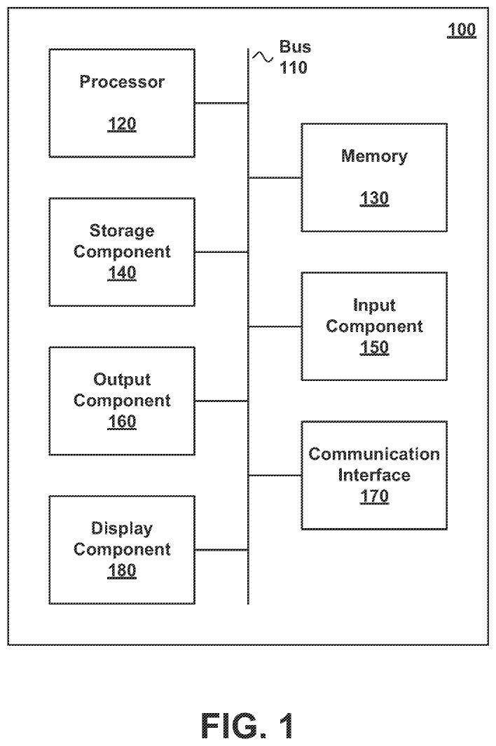

FIG. 1 is diagram of an example processing device. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, and a communication interface 170. The set of components of the device 100 may be communicatively coupled via a bus 110.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, and the communication interface 170.

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

The device 100 may perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

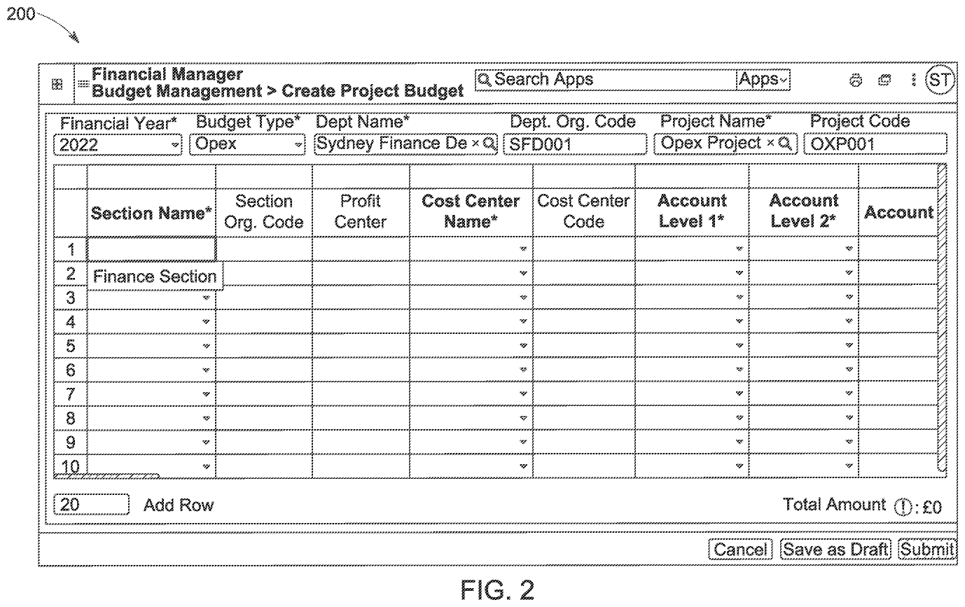

FIG. 2 illustrates an example user interface 200 that displays an electronic spreadsheet. The user interface may be displayed on the device 100 (FIG. 1). As an example, the spreadsheet may be configured in accordance with a budget or a financial planning project. For example, the spreadsheet may be configured in accordance with specifying a financial year (204A), a budget type (204B), a department name (204C), a department organization code (204D), a project name (204E), or a project code (204F). As illustrated in FIG. 2, the electronic spreadsheet includes a plurality of data cells arranged in a plurality of rows and data columns.

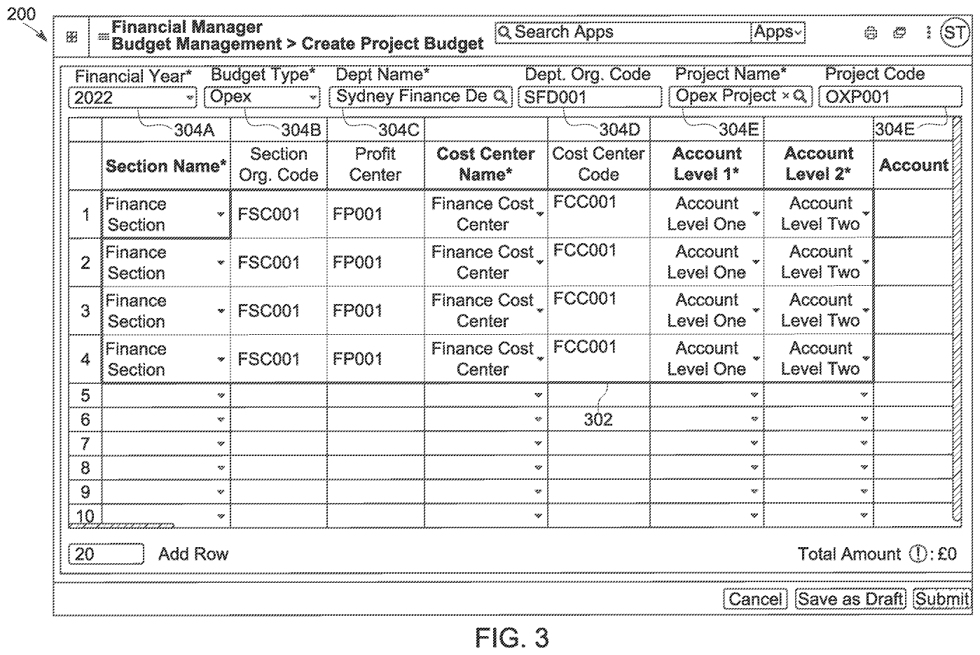

FIG. 3 illustrates an example in which bulk data 302 containing multiple rows and columns is copied and pasted in the spreadsheet displayed in user interface 200. The bulk data 302 may be copied from a previous spreadsheet such as a spreadsheet prepared in a different financial year. In another example, the bulk data 302 may be copied from the same spreadsheet. The bulk data 302 may be validated at the time of pasting the data in the spreadsheet by comparing the bulk data 302 with a master data configuration. The master data configuration may specify each of fields 204A-204F. For example, the master data configuration may specify that for a particular budget type (304B), one or more specific Cost Center Names (e.g., “Finance Cost Center”) are permitted.

Furthermore, individual columns in the bulk data may be validated against each other based on the master data configuration. For example, the master data configuration may specify that for a particular Section Name, the Cost Center Name may be restricted to one or more names. That is, the data column for Cost Center Name is dependent on the data column for Section Name. As another example, the master data configuration may specify that for a particular Account Level 1, specific Account Level 2 parameters (e.g., “Account Level Two”) are permitted. Furthermore, each of fields 204A-204F may be compared with each other. For example, the “Dept. Org. Code” may be restricted to specific values for a specified “Dept. Name.” The data validation may be performed for each dependent column for each row in the bulk data.

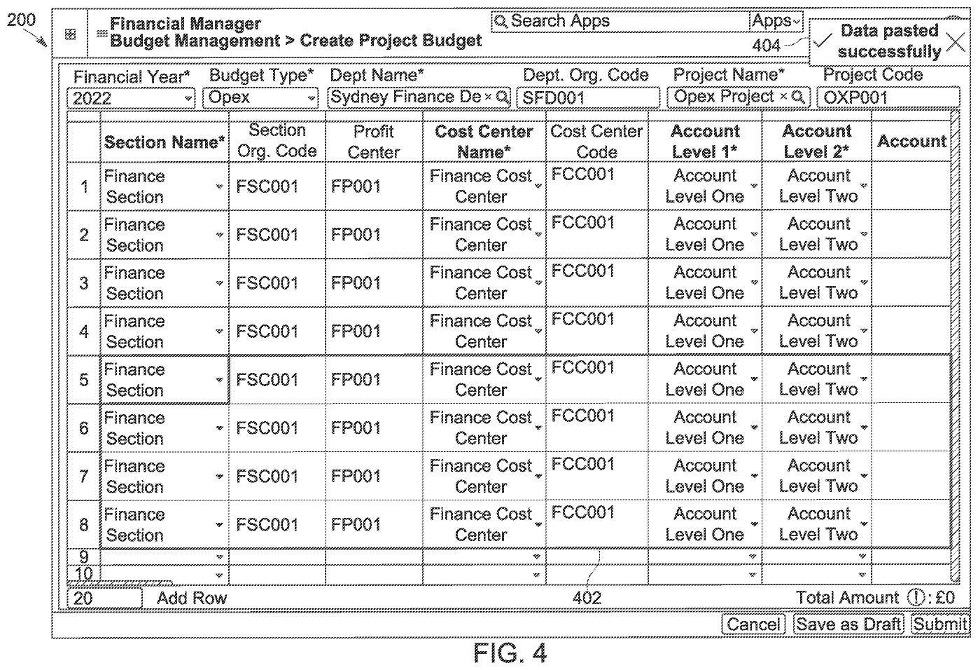

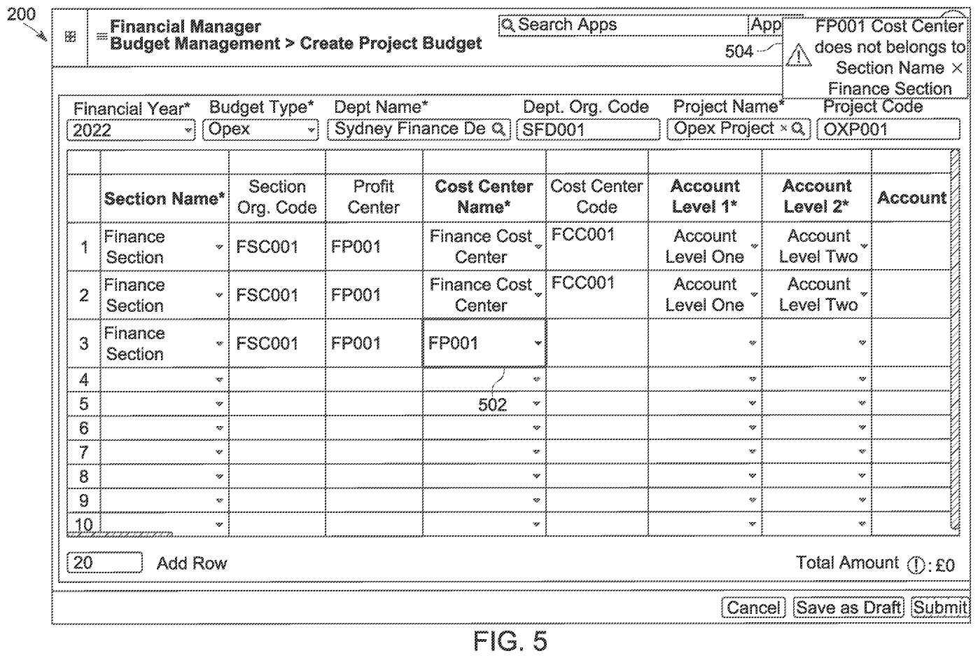

FIG. 4 illustrates an example in which bulk data 402 is successfully copied and pasted in a spreadsheet. For example, after bulk data 402 is pasted and validated with a master data configuration, a message 404 indicating the pasting is successful is displayed in the user interface 200. FIG. 5 illustrates an example in which bulk data is not successfully pasted into the spreadsheet. For example, at the time of pasting, the comparison of the master data with the bulk data may indicate that a proper Cost Center Name is not specified for row 3 (502). When bulk data is not validated, an error message 504 indicating the error may be displayed. For example, the error message 504 may provide text stating that “FP001 Cost Center does not belong to Section Name Finance Section.” Furthermore, the data cell or data cells in the spreadsheet containing the error (502) may be highlighted.

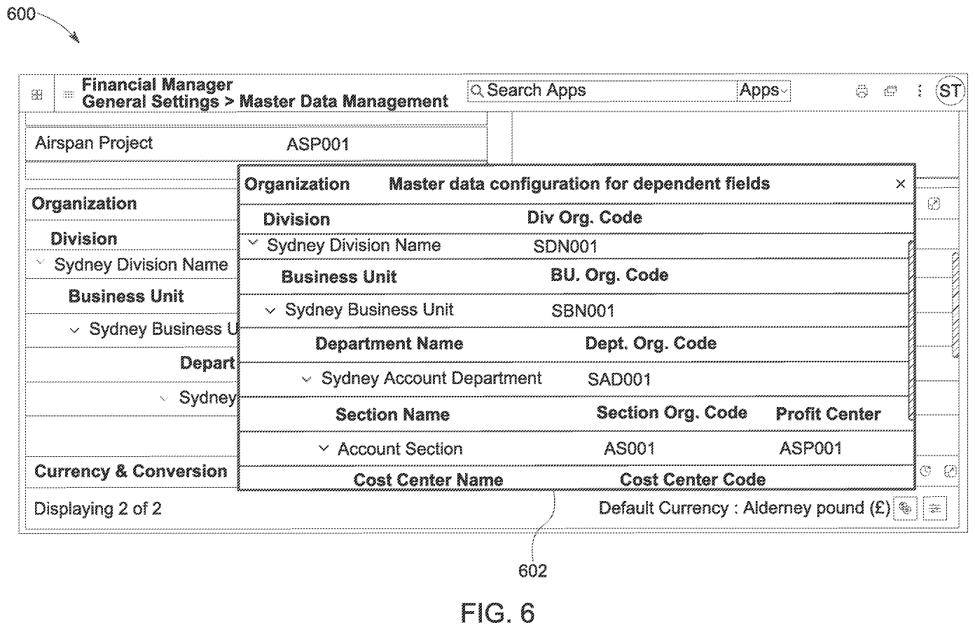

FIG. 6 illustrates an example user interface 600 for configuring or updating a master data configuration. The user interface 600 may display a window 602 that permits a user to configure the master data. For example, as illustrated in FIG. 6, a user can set a specific permitted “Dept. Org. Code” for a particular “Department Name.” Furthermore, a user can set permitted values for “Section Org. Code” and “Profit Center” for a particular “Section Name.”

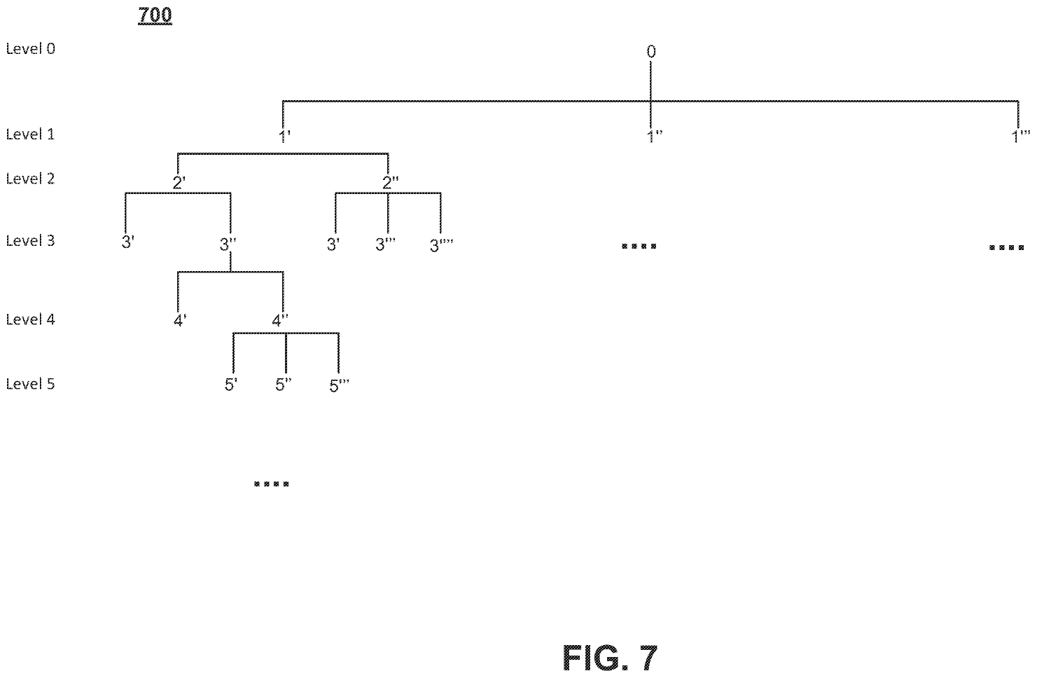

In some embodiments, the master data configuration organizes the data in a hierarchical relationship. FIG. 7 is diagram illustrating an example hierarchical relationship of the master data configuration. For example, the top level (Level 0) may signify a specific company or organization. As illustrated in FIG. 7, Level 1 may have values 1′, 1″, and 1′″. For example, Level 1 may corresponds to permitted Department Names 204C (FIG. 2). Each of values 1′, 1″, and 1′″ in Level 1 may have a hierarchical relationship with other levels. As an example, the hierarchical relationship of 1′ for Levels 2-5 is illustrated in FIG. 7.

As illustrated in FIG. 7, value 1′ may also be associated with values 2′ and 2″ for Level 2. That is, values for Level 2 are dependent on the value 1′ for Level 1. While Level 1 may correspond to Department Names, Level 2 may correspond to the data column for Section Name. For example, when the Section Name has the value 2′, a dependent data column may be value 3′ or 3″, and when the section name has the value 2″, the dependent data column may be value 3′, 3′″, or 3″″. Similar dependencies are illustrated in Levels 4 and 5. The hierarchical relationship illustrated in FIG. 7 may also be used to perform data validation. For example, when the Section Name has the value 2′, and the value in a dependent data column is 3′″, an error message may be displayed indicating the value 3′″ is invalid.

In some embodiments, the master data configuration may be stored in a central remote database. For example, the master data configuration may be accessed and updated by multiple devices 100 (FIG. 1) via a network such as the aforementioned networks in FIG. 1. In some embodiments, the master data configuration may be downloaded from the central remote database and locally stored at each device 100. If the master data configuration is downloaded and locally stored on a device 100, the master data configuration may be updated periodically with an updated master data configuration downloaded from the central remote database. In some embodiments, the master data configuration may be searched via a Structured Query Language (SQL) query.

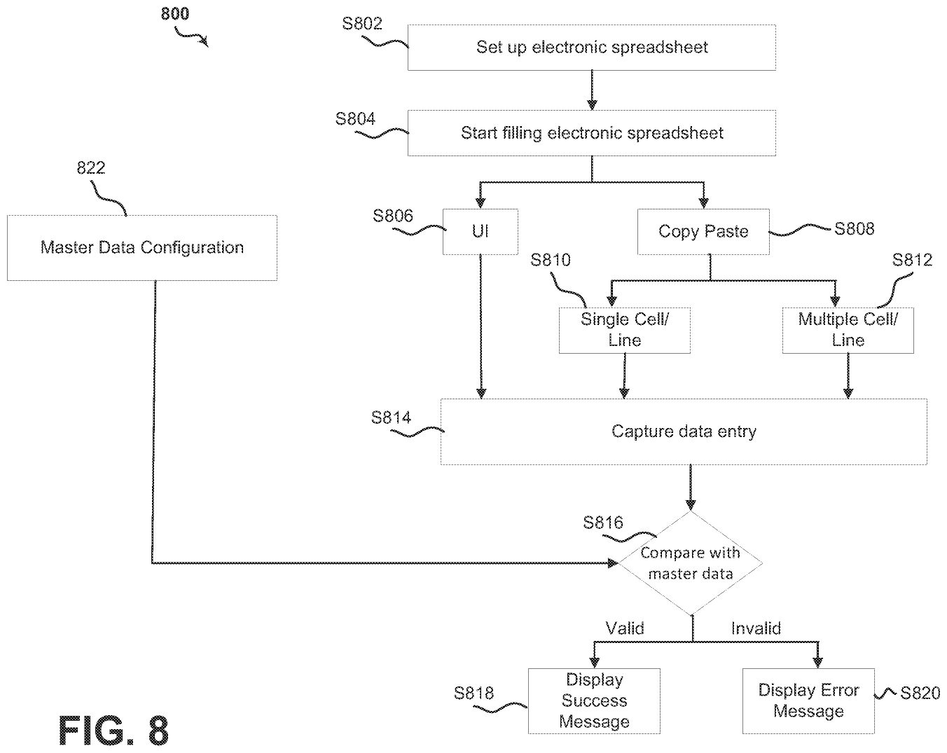

FIG. 8 is a flowchart that illustrates an example process 800 for validating data. The flowchart illustrated in FIG. 8 may be performed by device 100 (FIG. 1). The process may start at step S802 where an electronic spreadsheet is set up. The spreadsheet may be set up as part of a budget planning process for a department budget or project budget. A user may set up or initialize a spreadsheet by selecting a Financial Year (204A), Budget Type (204B), Department Name (204C), etc., as illustrated in FIG. 2. The process proceeds to step S804 where the electronic spreadsheet is filled. The spreadsheet may be filled by data entry in individual data cells utilizing a user interface that displays the spreadsheet (S806). The spreadsheet may also be filled by a copy-paste function (S808).

If the spreadsheet is filled by a copy and paste function, data may be pasted as a single cell/line (S810) or a multiple cell/line (S812). After data is entered via step S806, S810, or S812, the data entry is captured (S814) and subsequently compared with a master data configuration (S816). The master data configuration may contain any one of fields 204A-204F and any of the columns of the spreadsheet illustrated in FIG. 2, and any of the fields illustrated in FIG. 6. The master data configuration may also be organized in a hierarchical relationship as illustrated in FIG. 7. If the pasted data is validated, a success message is displayed (S818) as illustrated in FIG. 4, for example. If the pasted data is not validated, an error message is displayed (S820) as illustrated in FIG. 5, for example. Each field or cell in the spreadsheet containing an error may be highlighted. Steps S804-S820 may be repeated each time bulk data is entered into the spreadsheet.

Multi-row copy-paste functionality for dependent fields provides the significantly advantageous features of verifying bulk data with improved efficiency and accuracy. Particularly, the embodiments disclosed herein provide significant efficiencies over a user filling an individual data cell of a spreadsheet and validating each individual data cell.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

The above disclosure also encompasses the embodiments listed below:

(1) A method performed by at least one processor for data validation in an electronic spreadsheet displayed in a user interface, the method including: receiving a selection of a set of data that includes a plurality of data cells arranged in at least one row and a plurality of data columns; receiving a location in the electronic spreadsheet for insertion of the set of data; after receiving the location in the electronic spreadsheet, validating the set of data based on a master data configuration stored in one or more databases; and after validating the set of data, displaying a message in the user interface indicating whether the validating the set of data is successful.

(2) The method of feature (1), in response to determining the validating the set of data is successful, the set of data is inserted in the electronic spreadsheet, and the message displays a success message.

(3) The method of feature (1), in response to determining the validating the set of data is not successful, an indication of a location of one or more errors is provided in the electronic spreadsheet, and the message displays an error message.

(4) The method of feature (3), in which the indication of the location of the one or more errors includes a highlighting of one or more data cells in the electronic spreadsheet that includes erroneous data.

(5) The method of any one of features (1)-(4), in which the master data configuration specifies a relationship between a first data column in the plurality of data columns and a second data column in the plurality of data columns.

(6) The method of feature (5), in which the relationship specifies that when a data cell in the at least one row and first data column has a specific value, a data cell in the at least one row and the second data column is limited one or more other values.

(7) The method of feature (5) or (6), wherein the set of data includes at least one data column in the plurality of data columns that is not specified in the master data configuration.

(8) The method of any one of features (1)-(7), in which the master data configuration specifies a relationship between at least one data column in the plurality of data columns and at least one field not included in rows and data columns of the electronic spreadsheet.

(9) The method of any one of features (1)-(8), in which the set of data includes a plurality of rows including the at least one row, and wherein the validating is performed for each data column specified in the master data configuration for each row.

(10) The method any one of features (1)-(9), in which the master data configuration is arranged in a hierarchical relationship having a plurality of levels.

(11) The method of any one of features (1)-(10), in which the electronic spreadsheet is a first electronic spreadsheet, and the set of data is sourced from a second electronic spreadsheet different from the first electronic spreadsheet.

(12) The method of any one of features (1)-(11), in which the receiving the location in the electronic spreadsheet for insertion of the set of data includes a paste function that identifies the location in the electronic spreadsheet for pasting the set of data, and in which the validating the set of data is performed at a time of pasting of the set of data in the electronic spreadsheet.

(13) An apparatus for data validation in an electronic spreadsheet displayed in a user interface includes at least one memory configured to store computer program code; and at least one processor configured to access said at least one memory and operate as instructed by said computer program code. The computer program code includes first receiving code configured to cause at least one of said at least one processor to receive a selection of a set of data that includes a plurality of data cells arranged in at least one row and a plurality of data columns, second receiving code configured to cause at least one of said at least one processor to receive a location in the electronic spreadsheet for insertion of the set of data, after reception of the location in the electronic spreadsheet, validating code configured to cause at least one of said at least one processor to validate the set of data based on a master data configuration stored in one or more databases, and after validation of the set of data, displaying code configured to cause at least one of said at least one processor to display a message in the user interface indicating whether the validating the set of data is successful.

(14) The apparatus of feature (13), in which in response to a determination the validating the set of data is successful, the set of data is inserted in the electronic spreadsheet, and the message displays a success message.

(15) The apparatus of feature (13), in which in response to a determination the validating the set of data is not successful, an indication of a location of one or more errors is provided in the electronic spreadsheet, and the message displays an error message.

(16) The apparatus of feature (15), in which the indication of the location of the one or more errors includes a highlighting of one or more data cells in the electronic spreadsheet that includes erroneous data.

(17) The apparatus of any one of features (13)-(16), in which the master data configuration specifies a relationship between a first data column in the plurality of data columns and a second data column in the plurality of data columns.

(18) The apparatus of feature (17), in which the relationship specifies that when a data cell in the at least one row and first data column has a specific value, a data cell in the at least one row and the second data column is limited one or more other values.

(19) The apparatus of feature (17) or (18), in which the set of data includes at least one data column in the plurality of data columns that is not specified in the master data configuration.

(20) A non-transitory computer readable medium having instructions stored therein, which when executed by a processor cause the processor to perform a method for data validation in an electronic spreadsheet displayed in a user interface, the method including receiving a selection of a set of data that includes a plurality of data cells arranged in at least one row and a plurality of data columns; receiving a location in the electronic spreadsheet for insertion of the set of data; after receiving the location in the electronic spreadsheet, validating the set of data based on a master data configuration stored in one or more databases; and after validating the set of data, displaying a message in the user interface indicating whether the validating the set of data is successful.

What is claimed is:

1. A method performed by at least one processor for data validation in an electronic spreadsheet displayed in a user interface, the method comprising:
receiving a selection of a set of data that includes a plurality of data cells arranged in at least one row and a plurality of data columns;
receiving a location in the electronic spreadsheet for insertion of the set of data;
after receiving the location in the electronic spreadsheet, validating the set of data based on a master data configuration stored in one or more databases; and
after validating the set of data, displaying a message in the user interface indicating whether the validating the set of data is successful.

2. The method of claim 1, in response to determining the validating the set of data is successful, the set of data is inserted in the electronic spreadsheet, and the message displays a success message.

3. The method of claim 1, in response to determining the validating the set of data is not successful, an indication of a location of one or more errors is provided in the electronic spreadsheet, and the message displays an error message.

4. The method of claim 3, wherein the indication of the location of the one or more errors includes a highlighting of one or more data cells in the electronic spreadsheet that includes erroneous data.

5. The method according to claim 1, wherein the master data configuration specifies a relationship between a first data column in the plurality of data columns and a second data column in the plurality of data columns.

6. The method according to claim 5, wherein the relationship specifies that when a data cell in the at least one row and first data column has a specific value, a data cell in the at least one row and the second data column is limited one or more other values.

7. The method of claim 5, wherein the set of data includes at least one data column in the plurality of data columns that is not specified in the master data configuration.

8. The method according to claim 1, wherein the master data configuration specifies a relationship between at least one data column in the plurality of data columns and at least one field not included in rows and data columns of the electronic spreadsheet.

9. The method according to claim 1, wherein the set of data includes a plurality of rows including the at least one row, and wherein the validating is performed for each data column specified in the master data configuration for each row.

10. The method according to claim 1, wherein the master data configuration is arranged in a hierarchical relationship having a plurality of levels.

11. The method of claim 1, wherein the electronic spreadsheet is a first electronic spreadsheet, and the set of data is sourced from a second electronic spreadsheet different from the first electronic spreadsheet.

12. The method of claim 1, wherein the receiving the location in the electronic spreadsheet for insertion of the set of data includes a paste function that identifies the location in the electronic spreadsheet for pasting the set of data, and wherein the validating the set of data is performed at a time of pasting of the set of data in the electronic spreadsheet.

13. An apparatus for data validation in an electronic spreadsheet displayed in a user interface, the apparatus comprising:
at least one memory configured to store computer program code; and
at least one processor configured to access said at least one memory and operate as instructed by said computer program code, said computer program code including:
first receiving code configured to cause at least one of said at least one processor to receive a selection of a set of data that includes a plurality of data cells arranged in at least one row and a plurality of data columns,
second receiving code configured to cause at least one of said at least one processor to receive a location in the electronic spreadsheet for insertion of the set of data,
after reception of the location in the electronic spreadsheet, validating code configured to cause at least one of said at least one processor to validate the set of data based on a master data configuration stored in one or more databases, and
after validation of the set of data, displaying code configured to cause at least one of said at least one processor to display a message in the user interface indicating whether the validating the set of data is successful.

14. The apparatus of claim 13, wherein in response to a determination the validating the set of data is successful, the set of data is inserted in the electronic spreadsheet, and the message displays a success message.

15. The apparatus of claim 13, wherein in response to a determination the validating the set of data is not successful, an indication of a location of one or more errors is provided in the electronic spreadsheet, and the message displays an error message.

16. The apparatus of claim 15, wherein the indication of the location of the one or more errors includes a highlighting of one or more data cells in the electronic spreadsheet that includes erroneous data.

17. The apparatus according to claim 13, wherein the master data configuration specifies a relationship between a first data column in the plurality of data columns and a second data column in the plurality of data columns.

18. The apparatus according to claim 17, wherein the relationship specifies that when a data cell in the at least one row and first data column has a specific value, a data cell in the at least one row and the second data column is limited one or more other values.

19. The apparatus of claim 17, wherein the set of data includes at least one data column in the plurality of data columns that is not specified in the master data configuration.

20. A non-transitory computer readable medium having instructions stored therein, which when executed by a processor cause the processor to perform a method for data validation in an electronic spreadsheet displayed in a user interface, the method comprising:
receiving a selection of a set of data that includes a plurality of data cells arranged in at least one row and a plurality of data columns;
receiving a location in the electronic spreadsheet for insertion of the set of data;
after receiving the location in the electronic spreadsheet, validating the set of data based on a master data configuration stored in one or more databases; and
after validating the set of data, displaying a message in the user interface indicating whether the validating the set of data is successful.
